(19) United States
(12) Patent Application Publication
(10) Pub. No.: US 2014/0114735 A1
(43) Pub. Date: Apr. 24, 2014

(54) SYSTEM AND METHOD FOR USING A FINANCIAL CONDITION ALGORITHM TO PROCESS PURCHASES AND ADVERTISEMENTS

(71) Applicants: Thomas M. ISAACSON, Huntingtown, MD (US); Cary P. JENKINS, Alpine, UT (US)

(72) Inventors: Thomas M. ISAACSON, Huntingtown, MD (US); Cary P. JENKINS, Alpine, UT (US)

(21) Appl. No.: 14/046,444

(22) Filed: Oct. 4, 2013

Related U.S. Application Data
(60) Provisional application No. 61/715,508, filed on Oct. 18, 2012.

(51) Int. Cl. G06Q 20/42

(52) U.S. Cl. CPC G06Q 20/42
USPC 705/14.23; 705/44; 705/26.7

(57) ABSTRACT

The system provides a probability of loan default to a purchaser to aid in purchase decision making and financial planning. A user creates an account with a purchasing system prior to purchasing a product and/or service. The user receives an indication of a purchasing transaction of a product by the user. Prior to completion of the purchasing transaction, the system performs an analysis of a loan default probability or financial condition of the user presented as an analysis. The system presents an interactive notice to the user indicating that the loan default probability or financial condition is above a threshold and receives from the user via the interactive notice one of an indication to complete or discontinue the purchasing transaction.

### PRIORITY

The present application claims priority to Provisional Application No. 61/715,508, filed Oct. 18, 2012, the content of which is incorporated herein by reference in its entirety.

### BACKGROUND

1. Technical Field

The present disclosure relates to purchasing of products and/or services and more specifically to a system and method of providing a probability of default value or a financial condition evaluation to a purchaser to aid in making purchase decisions.

2. Introduction

It is often necessary to provide purchasers with financial loans to cover a portion of a large purchase such as a home, automobile, boat, college education, furniture, etc. Credit card companies and other entities that provide financial loans to individuals utilize credit scores to evaluate credit risk and determine whether to give loans. A credit score is computed based on a purchaser's credit history that includes information such as past borrowing and repaying of loans. From the credit score, lenders can determine whether to offer loans and can determine interest rates for loan repayment.

While the credit score can be a useful tool in determining loan eligibility, it has limitations. Because the score can be reduced based on factors outside a purchaser's control, it is not always a good evaluation of credit worthiness. The credit rating is one number and does not provide much detail about a purchaser's ability to repay loans. Further, it does not provide guidance to the purchaser about their own ability to repay a loan or aid in purchase decision making.

Further, many people avoid closely watching their financial condition. They may have a 401K program but not be contributing enough. Monitoring their financial condition may not be done because people have a mental block about dealing with bad news and would rather proceed on a day to day basis just getting by. Making decisions also that can place people on a track of stronger financial stability also can be difficult in the short term. For example, someone on a tight budget may have a difficult time putting an extra $100 or $200 per month into a savings or retirement plan.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

What is needed is a system that can identify the financial condition of a person or a household, or a business or any entity, and then utilize that information in an algorithm that will analyze their purchasing decisions and report or prevent purchases that would damage their financial condition. Their financial condition may be their probability of default on one of their loans (car loan, mortgage, student loan, etc.), or may relate to their retirement plans (i.e., they are on a track to retire at 65, but this purchase will delay that track until 70) or some other aspect of their financial condition. A system is needed that provides more information than strictly utilizing credit scores to help purchasers make purchasing decisions. Once the system is set up, users can proceed to go about their purchasing decisions without worrying about how their purchases affect their financial condition because the system will monitor their purchases and warn them of a purchase that is problematic before it is completed. Because data about purchasers' likelihoods of defaults on loans is available via financial software, the data can be used in a manner that aids a user (and a merchant) in determining whether a particular purchase should be made. One aspect of this disclosure is that it operates in a way that users can just go about their purchasing decisions in the normal fashion without thinking about their overall financial strategy. The system, in one embodiment, intercepts purchases after they are initiated and can stop processing those purchases that would be detrimental to the financial condition of the purchaser.

The system can automatically gather financial information for users from different sources such as a mortgage company, student loan entity, bank, credit card, investment and retirement accounts to present users with their financial snapshots. Software such as mint.com and Quicken® and Money allow users to set budgets, track spending and pay bills. Financial software allows users to stay up-to-date with financial goal progress by sending emails and providing mobile applications for users to track their finances on-the-go. Users can receive alerts of upcoming bills, low account balances, credit availability, fee charges, unusual charges, large purchases, etc. Users undoubtedly benefit from these financial tools because all of their financial information is gathered together in one place to aid users in making good financial choices even when away from home. Currently, financial software can provide financial snapshots for users but do not provide any mechanism for automatically alerting users during a potentially poor financial transaction. In other words, they only analyze the data in your account after you've made a purchasing decision. This disclosure utilizes such information to evaluate potential purchases and warn users before they complete such purchases. Financial software that provides a financial snapshot of a purchaser can be utilized in determining whether a purchaser can afford to make a purchase.

Disclosed are systems, methods, and non-transitory computer-readable storage media for purchasing that provides a loan default probability or financial condition value or a financial condition evaluation to a purchaser to aid in making a purchase decision. A purchaser can set up a user account with the purchasing system that allows the purchaser to shop in their normal fashion, without consciously thinking about using the system when shopping. As the user begins to make a purchase or initiates a purchase in some fashion, the system automatically notifies the user when a potentially risky financial transaction is in process via a smartphone, computer, etc. for verification that the user really does want to take the risk. Alternately, the system can allow a user to input information about purchasing a product without starting a purchasing transaction, to receive a financial analysis if the user were to purchase the product. I.e., a user interface allows the user to input potential data on a purchase they are interested in making to evaluate the effect of that purchase on their financial condition.

A system implementing the method receives an indication of a purchasing transaction initiation by a user. The initiation can occur through a mobile device application in which the device includes the ability to make a purchase using a user's purchasing account such as Amazon, PayPal, ebay or their normal debit/credit accounts. The initiation can occur through other mechanisms such as via a computer or physically at a store through one of a mouse click, product barcode scan and credit card swipe, for example. Prior to completion of the purchasing transaction, the system can perform an analysis of a loan default probability or financial condition or the financial condition implication of that purchase, if it were to be completed. The system can compute the loan default probability or financial condition using financial software that includes a financial snapshot of the user such as provided by Mint or Quicken. The probability can be based on one or more of bank account balances, credit card account balances, loan account balances, income, assets and other debts. The evaluation can also be based on outside data such as the user's location, general financial conditions, weather conditions, market trends, political trends, etc. Any data that is relevant to the predicted financial condition of the particular user can be input to the algorithm.

An interactive notice is presented to the user via a smartphone or other ways indicating that the loan default probability or financial condition effect is above an acceptable threshold. The interactive notice can be a text message, email, instant message, phone call, etc. and is intended to alert the user during a potentially risky financial transaction such as during an automobile purchase. The interactive notice can include one or more alternate purchasing options having loan default probabilities or risks below the threshold, the alternate purchasing options including products that are similar to or different than the original product. These alternate purchasing options can be supplied using advertisements for products having loan default probabilities below a particular threshold. Next, the system receives from the user via the interactive notice one of an indication to complete the purchasing transaction and an indication to discontinue the purchasing transaction. The user can send an email, text message, instant message, reply to a phone call, etc. to indicate the completion or termination of the questionable transaction. Then the system provides an instruction to continue with the purchasing transaction when the indication is to complete the purchasing transaction. In this way, the system can alert the purchaser that the risk of defaulting on a loan is above an acceptable limit.

In one embodiment, a merchant can adjust the price of a product when the loan default probability or financial condition is above a threshold at an original price, essentially legitimately negotiating a fair price with the purchaser. A system implementing the method receives an indication of a purchasing transaction initiation of a product having a price between a user and a merchant. The initiation can occur via a smartphone, computer or physically by means such as a mouse click, product barcode scan and credit card swipe, for example. The system receives an analysis of a loan default probability or financial condition of the user based on the price and presents at least a portion of the analysis to at least one of the user and the merchant in a presentation form. The merchant can send an indication of an adjusted price for the product based on the presentation, for example if purchasing a $25,000 new car puts a user over their threshold, the merchant can potentially lower the price to $23,000. The merchant and/or the user can receive a second analysis of a second loan default probability or financial condition based on the adjusted price for the product and when the second loan default probability or financial condition is below a threshold, the purchasing transaction can be completed at the adjusted price. The advantage is that a merchant can adjust the price of a product accordingly to a level considered safe by the user, ensuring confidence in both the merchant and the user that the user can afford the car.

Another embodiment relates to providing advertisements in the context of the notifications and analysis disclosed herein. By having the ability to stop an ongoing purchase of an item because the purchase of that item would affect the buyer negatively, the system is in a unique position to offer advertisements for items that, if purchased, do not negatively affect the user's financial condition. Other general advertising can be triggered and/or filtered through an algorithm that analyzes the financial affect on the recipient of the advertisement if the recipient were to purchase the product advertised. In this manner, the recipient can be confident if an ad is received for a more expensive item like a car or a vacation package that given the user's personal financial condition, they can afford to buy the advertized item.

In another embodiment, the loan default probability or financial condition is utilized in maintaining an individual's financial portfolio in good financial health. A user can utilize the purchasing system to not only alert the user of potential poor financial choices during a financial transaction, but can use the system to alert the user when a loan default probability or financial condition rises above the established threshold due to external events such as a stock market crash. The system can periodically generate a loan default probability or financial condition and compare it against the threshold. When the probability rises to an unacceptable level, the system can suggest ways to keep the probability acceptable such as transferring additional money into an IRA account to account for money lost during the stock market crash. In this regard, utilizing the algorithm, a plan can be proposed in which additional payments to retirement, or assets to be sold, etc. can be implemented. The user can evaluate the plan and click “yes” or interact in any fashion with a proposal interface to cause the plan to be implemented. Then the user can continue to go about their normal life making purchases without thinking about the plan because it will be implemented and actively operating.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an exemplary purchasing system;

FIG. 3 illustrates a purchasing method embodiment;

FIG. 4 illustrates an exemplary interactive notice;

FIG. 5 illustrates an example system embodiment; and

FIG. 6 illustrates an example method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

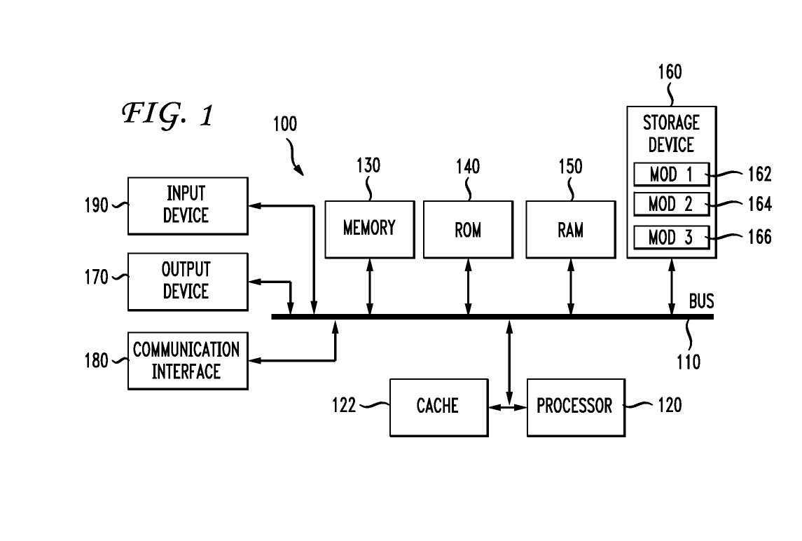

The present disclosure addresses the need in the art for a system that helps users in a simple way to manage their finances and their purchasing decisions. A benefit of the disclosed system is that once the parameters are set up, an algorithm applies for each individual user, household, or company that can monitor purchasing activity and perform evaluations of purchases that have been initiated, but not completed, as though they had been completed and thus considers the effect of a transaction on the user's financial condition. If a threshold is passed, then the system warns the user of the negative effect the transaction would have on their financial condition and prompts them to confirm the transaction and/or presents advertisements of optional purchases that prevent a negative change in their financial condition. Users can then make purchases confidently knowing that they will be warned before an inappropriate purchase is made. A system, method and non-transitory computer-readable media are disclosed which aids purchasers in making good financial decisions that are based on their actual ability to repay a loan or their overall financial condition. Other embodiments relate to advertising that is preprocessed to insure that if the recipient of the advertisement where to buy the advertised item, it would not negatively affect their financial condition. Other embodiments also relate to ongoing approaches to helping users to maintain a proper balance in their financial condition and to enable specific plans to be implemented easily when the user becomes out of balance financially. These variations shall be discussed herein as the various embodiments are set forth. The disclosure now turns to FIG. 1.

A brief introductory description of a basic general purpose system or computing device in FIG. 1 which can be employed to practice the concepts is disclosed herein. A more detailed description of purchasing will then follow. With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

For the sake of clarity, the method is discussed in terms of an exemplary system 100 as shown in FIG. 1 configured to practice the method. The steps outlined herein are exemplary and can be implemented in any combination thereof, including combinations that exclude, add, or modify certain steps.

### Intercepting Purchases

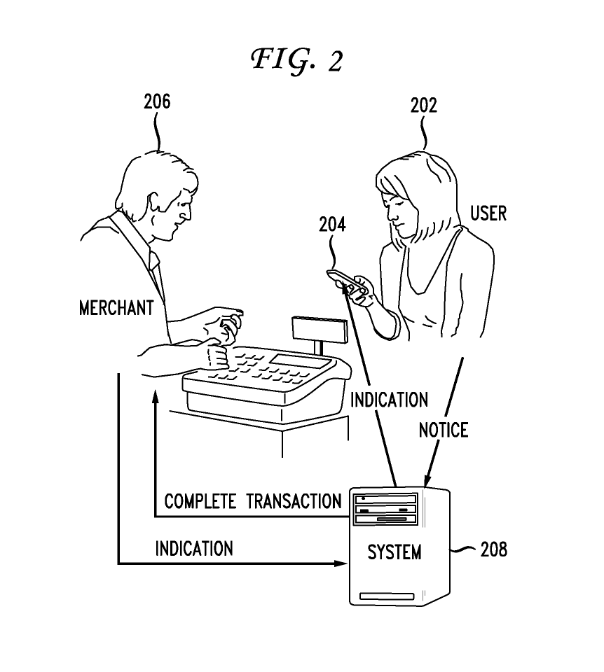

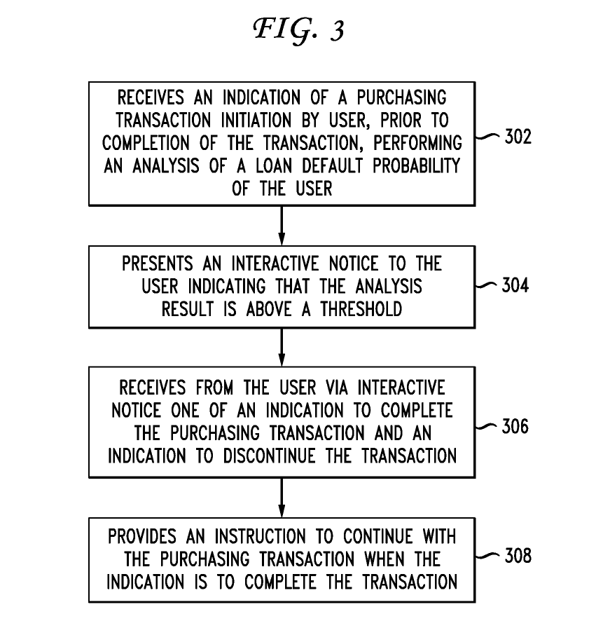

Having disclosed some components of a computing system, the disclosure now turns to FIG. 2, which illustrates an exemplary purchasing system. FIG. 3 illustrates a purchasing method embodiment.

In the first embodiment, the system monitors a user's purchases and can intercept a purchase that has been initiated. The approach enables users to just go about their purchasing activity until they are about to make a bad purchase that can affect their financial condition.

Assume a user 202 decides to purchase a 2012 Honda Civic EX from a car salesman (merchant) 206 at a price of $28,000 utilizing a purchasing system 208. The user can set up a user account with the purchasing system prior to shopping for the car, which allows the system to access financial information of the user and to monitor the user financial transactions as they are initiated. The account setup process can be accomplished in several ways including via financial software such as Mint or Money, through a bank or credit card company, for example. During account setup, the purchasing system is connected to the user's financial information. As a user initiates the purchase of the car, either through a loan application processing or through the use of a credit card, debit card, or any other electronic purchasing mechanism, the system will identify that the transaction has been initiated. Before the transaction is completed, the system will evaluate the effect on the user's financial condition if they spend $28,000 on the car. The effect can be the overall price, or the burden of the monthly payments, etc. If the purchase is made in cash, a user interface can be presented to the user to manually enter in the price of the purchase into a mobile application r some other interface so that the system can perform a similar evaluation and provide feedback on how the purchase affects the user's financial condition.

The system evaluates the financial condition as though the purchase is completed. The system automatically notifies the user when a potentially risky financial transaction is in process via any mechanism such as a smartphone, computer, tablet, etc. The notification can simply be “Buying this car at this price will increase the probability that you will default on your home loan from 5% to 15%, we recommend against the purchase.” The user can verify that the purchase should go through or can stop the transaction. The system may pre-process other advertisements for other vehicles and present them at that time. The notification may state “This dealer has a similar vehicle at $20,000 that is a wiser purchase for you at this time, ask about the blue 2008 Honda Accord.” The concept of advertising within the context of an algorithm to analyze a user's financial condition is discussed more fully below.

In this manner, the user, with this system in place, can shop for a car in a normal fashion, without being concerned about using the system, and knowing that the system will alert the user when they are making a risky purchase. The user can then decide whether or not the risky purchase is worth it. The system allows the user to shop with confidence.

FIG. 3 illustrates a method embodiment. A purchasing system 208 receives an indication of a purchasing transaction initiation (302) of a car by a user 202, and prior to completion of the purchasing transaction of the car, the system performs an analysis of a loan default probability or financial condition of the user (304). The algorithm utilizes the known financial condition and then processes a potential transaction to evaluate the effect of the purchase on the user's financial condition. The user can indicate the initiation of a purchase in one of several ways, to include a barcode scan, smartphone application, credit card swipe and phone call, for example and can perform the initiation via a computer, phone, etc. An indication is any communication with the purchasing system 206 that indicates the start of a financial transaction for a product or a service between a merchant and a user. In one embodiment, the user can preview a purchase transaction prior to actually making a purchase to see if the financial transaction is within an acceptable boundary. For example, the user can use a smartphone app to input information about a potential purchase and can receive an analysis of their financial situation, instead of starting the purchase transaction. The analysis can include a loan default probability or financial condition that includes the price of the potential purchase, and can indicate whether the potential purchase (as though the user had completed the purchase) will put the user over the threshold. Allowing a user to preview a purchase can enable a more efficient shopping experience for the user and the merchant so that a user does not take valuable transaction time deciding whether to purchase a product.

The analysis of the loan default probability or financial condition can utilize a financial software account of the user such as Mint or Quicken to review a financial snapshot of the user. A financial snapshot can include information such as bank account balances, credit card balances, automobile loan balances, educational loan balances, mortgage account balances and so forth. The snapshot can include information such as interest rates on existing loans, income, loan repayment history such as indicated on a credit report, etc. The loan default probability or financial condition can be computed using any applicable financial information that is available and can range in number from zero to one hundred. For example, the system can compute the probability with the price of the car included in the user's outstanding loans. If the loan default probability or financial condition provided in the analysis is below the established threshold (306), the user completes the purchase transaction (312) of the car because the purchase is not considered risky. The threshold can be determined by either the user or the system. In one embodiment, the user may choose to raise their threshold to allow a particular purchase. In another embodiment, the user may lower their threshold when shopping for a car, for example if they know they have a problem in purchasing cars out of their price range. In another embodiment, the user can adjust their loan default probability or financial condition by increasing assets for example, selling a recreational vehicle and reducing debts.

When the loan default probability or financial condition is above an established threshold, the system presents an interactive notice (304) to the user 202 via her smartphone 204, for example, indicating that the loan default probability or financial condition of 25% for the car at the price of $28,000 is above the predetermined threshold of 18%. The interactive notice can be one of text message, email, instant message, tweet, phone call, etc. and can be delivered electronically via one of a smartphone, landline, pager, PDA, desktop, laptop and tablet devices, for example.

The system can receive from the user via the interactive notice one of an indication to complete the purchasing transaction and an indication to discontinue the purchasing transaction based on the loan default probability or financial condition (306). By choosing to complete the purchasing transaction, the user opts to go ahead and make the risky financial transaction despite the warning provided by the notice. When the user chooses to discontinue the transaction, the process is complete and the product is not purchased by the user. In some cases, users may want to make a risky purchase out of necessity, for example needing transportation to and from a job. In other cases, a user may decide that purchasing a leather couch that puts them over the threshold is not worth the risk and settle for a microfiber couch instead. When the user indicates to proceed with the transaction anyway, the system provides an instruction to continue with the purchasing transaction (308).

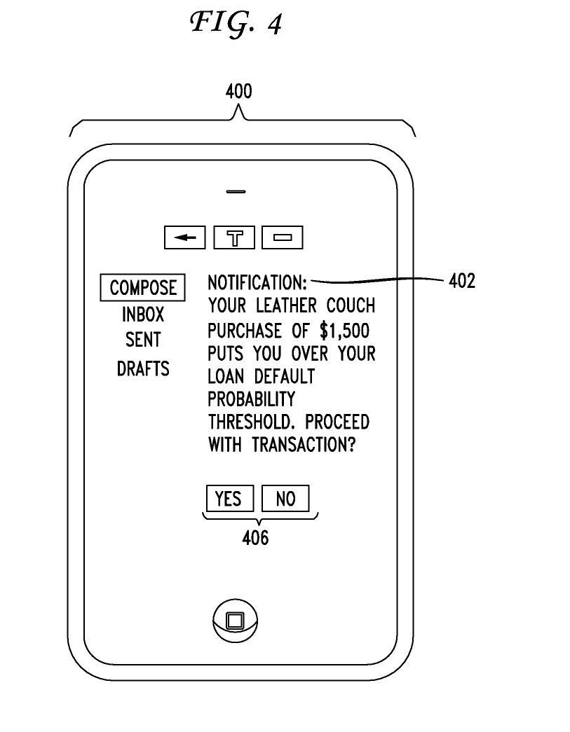

FIG. 4 illustrates an exemplary interactive notice displayed on a portable device 400 such as a smartphone or tablet device. A user 502 can receive a notification via email 402 on her smartphone 504 that reads “Your leather couch purchase of $1,500 puts you over your loan default probability or financial condition threshold. Proceed with transaction?” The user can indicate either “Yes” or “No” 406 to proceed with the transaction. The user can receive a similar notice via text messaging or instant messaging, or can receive an audio notice via an automated voice system capable of understanding a response. Any method of communicating with the user to indicate a potentially risky transaction is contemplated and should not be limiting in any way.

The interactive notice can include information about going over the threshold with the pending purchase and can optionally include alternate purchasing options by way of advertisements.

In another example, if the user desired to buy a certain car, the system can evaluate the cost of that potential purchase and given the circumstances, the system might change the timing of the purchase and proposes a schedule over a time period such as six months before the user should buy the car. The system may present a program to the user: “You should not buy this car right now because of the amount of credit card debt that you have. The monthly payment for this car is $600. If you take that amount and pay off your VISA card in six months, then you will be in a better position to buy this car. Click here to authorize an automatic deduction from your account of $600 to be applied to your VISA account starting Nov. 1, 2012 through May 2013.” The steps in this case are that the system intercepts the purchase, identifies a financial plan over a period of time, which, if the user accepts and adopts, places the user in a better financial condition in order for them to make the purchase that is currently desired. The system then, upon user acceptance in any fashion, will implement the plan, which can include an automatic deduction and payment plan. The financial plan can include a calculation that is based upon a monthly payment that would have been incurred if the current transaction were completed, i.e., the monthly payment for a car, house, or any other object or service.

The system could of course give the use options based on their financial condition. For example, if the system knows that the user has $1,000 of disposable income per month, and a monthly payment for a car that the user wants to buy would be $600, the system can present a financial plan in which the user can select a monthly payment between $500-$1000 (without having an option to pay more than they can accommodate), which would automatically adjust the time period of paying off the credit card. I.e., the system may propose a six month plan at $600 but the user may want a $1000 per month plan for 4 months to be able to buy the car sooner. Such a financial plan could also be based on interest rates, down payment amount, and so forth. For example, the system may determine that the user should pay $5,000 down on the car to make the payments a certain amount, and the financial plan might be to withdraw $1000 from their account for 5 months and hold that money in preparation for the down payment, whereas at the current time the user has no down payment and would pay more in interest over the life of the loan. As can be seen, there are a variety of schedules, timing, dollar amounts, and so forth that can go into an intelligence engine that structures financial plans around enabling users to make smart purchasing decisions.

### Strategic Advertising/Planning Strategies

In another embodiment, the moment when such a notice is provided to the user, i.e., when the user is in the act of buying something and being stopped based on the results of the algorithm from completing the transaction, is an important moment. It is a moment when the system has a lot of information about the user and their buying desires. The system can, in another embodiment, provide appropriate advertisements at this stage. Advertisements can include products in which the loan default probability or financial condition has been precomputed and determined to be less than the user's threshold. For example, when the Honda Civic having a loan default probability or financial condition of 25% puts the user over their threshold of 18%, the system can send advertisements to the user's smartphone for optional vehicles having lower loan default probabilities. For example, a used Honda Civic DX having a price of $13,000 and a loan default probability or financial condition of 17% can be sent to the user. Another type of vehicle such as a compact car or motorcycle having a lower loan default probability or financial condition can be sent to the user via an electronic device such as smartphone, computer, tablet, etc. Alternately, the system may send advertisements to the user for related products such as steering wheel covers, sound systems, tires and other such upgrades that would keep the loan default probability or financial condition below the threshold. These advertisements can be purchased using one-click technology, where the user need only click on the advertisement that is linked to a purchasing account of the user. Offering advertisements of other options allows a user to not feel stressed about finding a product for a reasonable price.

In one embodiment, the notice can include an option for the user to change the structure of their financial portfolio to allow the purchase. In other words, the system, knowing the person's financial condition, can perform an analysis that results in suggested changes elsewhere in their overall finances which, if implemented, would justify or make the purchase of the current item, if it were completed, safe. The change can be a one-time event, for example, adding a lump sum $2,000 to their retirement portfolio or adding $500 to their savings every month for 4 months. The user can opt to add $400 to their retirement portfolio for the next four months and to pay off one credit card of $1200 to then allow the purchase. The notice can include a one-click feature with a payment plan in place to allow the transaction, and the user need only click “accept” to go ahead with the plan and make the purchase.

The system, at the very moment in which the user is in the process of making a financial decision, can help to insure the financial condition maintains a certain financial stability level based on the transaction. If the user has their various assets such as workout equipment, tv's, computers, etc., cataloged, the system could note that if they sold their treadmill for $800 and put that money into retirement or to pay off credit card debt, then on balance, purchasing the car would not affect their financial condition. The system could negotiate with the user at that time with an “offer” to take their treadmill and place it on ebay with a floor price of $800 and if that sells, then allow them to buy the car. Or allow the car purchase to go through if the treadmill is put on ebay with no limit on the purchase price. The system could take a percentage of the sale price as payment for processing the transaction.

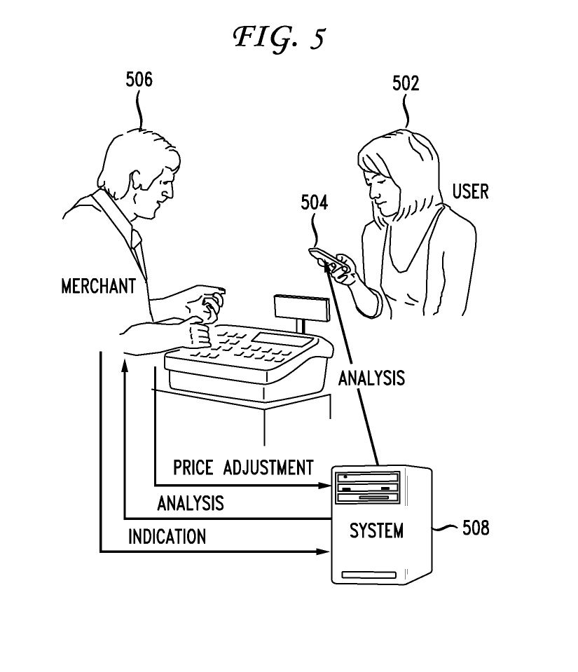

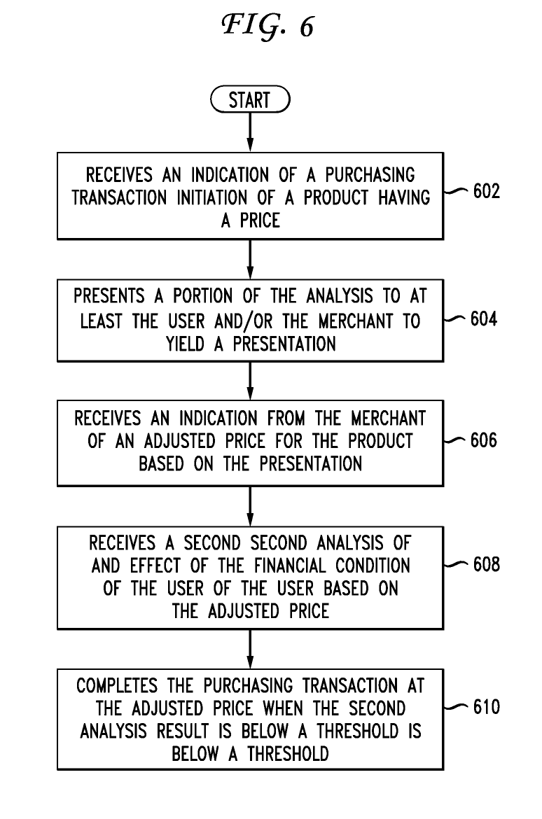

FIG. 5 illustrates an exemplary system utilizing the loan default probability or financial condition to set a price for a product or a service. FIG. 6 illustrates a method embodiment of utilizing the loan default probability or financial condition to set a price for a product or a service. A user 502 having a smartphone or other device 504 desires to purchase a leather couch having a price of $5,000 from LazBoy furniture (merchant) 506. A system 508 can receive an indication of a purchasing transaction initiation (602) of the couch via a credit card swipe by the merchant, or via an electronic purchasing application using the mobile device 504, for example. Alternate methods of initiating the purchasing transaction such as barcode scan via the user's smartphone or placing a virtual item in a virtual shopping cart while shopping on-line are possible. The particular mechanisms of detecting the initiation of a financial transaction is not material to this disclosure. An aspect of this disclosure is the general concept of detecting the initiation of the transaction and performing the appropriate analysis and if necessary, a notification, prior to the completion of the purchasing transaction. The system receives an analysis of a loan default probability or financial condition of the user based on the $5,000 price of the leather couch utilizing the user's purchasing system account that includes financial information. The data used by the algorithm can also include external data such as defaults of those in a similar geographical area, overall market conditions, time of day or time of year, foreign market data, etc. The account can be a virtual account and can include a snapshot image of the user's financial situation including information such as bank account balances, credit card account balances, car loans, assets, income and debts. Additional information such as outstanding loan interest rates, loan payoff dates, number of loans, etc. can be included in the snapshot to provide the purchasing system with the most information about a user's financial situation.

The system 508 can present at least a portion of the analysis to at least one of the user 502 and the merchant 506 as a presentation (604). The analysis can be presented to the merchant via a smartphone, email, text message, phone call, etc. Presenting the analysis to the merchant allows the merchant to definitively know if the purchase would be too great of a financial strain on the user. For example, when the merchant receives an analysis indicating that the $5,000 purchase of the leather couch gives the user a 20% loan default probability or financial condition and exceeds the threshold of 18%, the merchant can adjust the price accordingly. The merchant can adjust the price of the couch such that the loan default probability or financial condition is lowered to below the user's threshold, or can offer another couch for sale that would keep the user's loan default probability or financial condition below the threshold. The system 508 can receive an indication from the merchant of an adjusted price for the couch based on the presentation (606) and can receive a second analysis of a second loan default probability or financial condition of the user based on the adjusted price for the product (608). For example, when the merchant receives the original analysis indicating that the $5,000 price of the couch exceeds the user's loan default probability, the merchant lowers the price of the couch to $4,200 which brings the loan default probability or financial condition down to the threshold of 18%, an acceptable level. When the second loan default probability or financial condition is below a threshold, the system completes the purchasing transaction at the adjusted price (610). In this manner, the user can know that the adjusted price does not substantially affect their probability of default, and the merchant was able to complete a sale. Without this feature, parties are simply blindly negotiating over a price without actually knowing the impact the purchase will have on the user's finances.

The threshold discussed might be not just the user's threshold of their financial condition and/or ability to pay back loans but also could include the merchant's threshold. For example, the merchant might proceed with a sale where the probability of default on a loan for the coach is below 25%, although the user may set their threshold at 35%.

In this regard, while the transaction is initiated, the system may present a notification not to the buyer but to the merchant that a threshold has been passed and that the purchase should not go through, at least at that price. This notification can prevent a risky purchase from being made that could later cause the merchant to have to repossess the product. The analysis presented may help the merchant actually restructure a loan or reduce the price, however, to reduce the financial strain on the buyer and thus still complete the sale.

The purchasing system can be utilized in purchasing products and/or services from a merchant. For example, purchases such as furniture, computers, electronics, cars, rugs, appliances, etc. are examples of products. A user can purchase services such as remodeling or traveling utilizing the purchasing system. For example, a user initiates a purchasing transaction of a 10-day European vacation with a travel agent. Prior to the transaction, the user set-up an account with the system to receive alerts for purchases having a loan default probability or financial condition above a 15% threshold. The cost of the 10-day European vacation, if purchased, would cause the loan default probability to increase or negatively affect the financial condition of the family, so the user receives an interactive notice via his smartphone that he cannot afford the vacation. The user wants to take his wife on a ten year anniversary trip to Europe, so he decides to proceed with the purchasing transaction. The user indicates via his smartphone, that he is willing to accept the risk and potential financial strain to take his wife to Europe because he expects his tax return to arrive prior to the trip, which would improve his financial situation. The interactive notice can ask for mitigating data, such as the tax return, that the system may not know about. If the user indicates that a $15,000 tax return is going to pay for the trip, then the system reevaluates the financial condition with that data and withdraws the warning. Alternately, after receiving notice that the trip exceeds his threshold, the user can decide to instead accept an advertisement provided by the interactive notice and take his wife to Williamsburg for the weekend, allowing the user to stay below his 15% threshold. The purchasing system can be used whenever there is a financial transaction between a user and a merchant for goods and/or services.

The advertising component of this disclosure is novel. The advertisements presented in this case are those that have been cleared by the algorithm. In other words, if an advertisement for a 2008 Honda Accord is presented to the user, it will have been proceed by the system, as though the user has made the purchase, as not negatively affecting their financial condition. This advertisement can be presented in the process of interrupting a current sale in process, or may be any advertisement on a tablet, computer, mobile device, etc. The advertisement may be presented with a seal of approval of this system which would indicate to the user that it has been analyzed according to their personal financial condition and is approved for purchase. This analysis personalizes advertisements in a way that has not been done before and enables users to make purchases based on advertisements with confidence.

### On-Going Monitoring and Financial Adjustments

In another embodiment, the loan default probability or financial condition is utilized in maintaining an individual's financial portfolio in good financial health. A user can utilize the purchasing system to not only alert the user of potential poor financial choices during a financial transaction, but can use the system to alert the user when a loan default probability or financial condition problem rises above the established threshold due to external events such as a stock market crash. The system can periodically generate a loan default probability or financial condition and compare it against the threshold. Or, the system can be programmed to recalculate a loan default probability or financial condition whenever there are drastic events such as a stock market crash, large business buyout, natural disasters such as tsunamis and earthquakes, etc. When the probability rises to an unacceptable level, the system can suggest ways to keep the probability acceptable such as transferring additional money into a retirement account to account for the lost funds due to the stock market crash. The transfer can be a one-time event or can recur for a specified length of time. For example, a user loses $35,000 during a stock market crash, and the system notifies the user that his financial portfolio needs improvement. The system can suggest ways to remedy the situation such as transferring $500 a month for the next 5 years from the user's checking account to a retirement account to put the user back on track to retire at age 65. Instead of using a recurring transfer, the user can opt to make a one-time lump sum deposit to a retirement account after receiving a notification about the user's financial status. The user may decide to sell his yacht and deposit the money earned from selling off an asset to replenish the user's retirement account. In this way, the purchasing system not only alerts the user to potentially risky financial transactions, but also alerts the user when external events or other triggers have caused the user's financial portfolio to change. By utilizing the purchasing system, users can scrutinize their purchases more closely, and can be alerted when external events cause their financial position to change.

In one aspect, they system has pictures and descriptions of all the assets of the user. In these notifications, the system could be interconnected to ebay or some other on-line auctioning application, and help the user to sell assets that can raise money to place them in a better financial condition. With all the user data stored, the system could automatically place an item for sale on ebay and set the floor price according to what financial condition they are in and how much money they need to get back to the financial condition they need to be in. The system could also help with pricing of those items such that a floor price can be set that is based both on the market based price for that asset as well as the amount of money needed to help the user gain back their financially stable condition.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein not only apply to products but to services having a purchasing transaction. Those skilled in the art will readily recognize various modifications and changes that may be made to the principles described herein without following the example embodiments and applications illustrated and described herein, and without departing from the spirit and scope of the disclosure.

We claim:

1. A method comprising:
receiving an indication of a purchasing transaction initiation of a product by a user;
prior to completion of the purchasing transaction, performing an analysis, assuming the completion of the purchase, of an effect of the purchase on a financial condition of the user;
presenting an interactive notice to the user indicating that a change in the financial condition of the user would occur if the purchasing transaction where to be completed when the analysis yields a result which is above the threshold;
receiving from the user via the interactive notice one of an indication to complete the purchasing transaction and an indication to discontinue the purchasing transaction; and
providing an instruction to continue with the purchasing transaction when the indication is to complete the purchasing transaction.

2. The method of claim 1, wherein the interactive notice comprises at least one alternate purchasing option.

3. The method of claim 1, wherein the interactive notice comprises an alternate purchasing option that is selected based on an analysis that assumes the alternate purchase option was purchased and confirms that the change in the financial condition of the user would remain below the threshold if the alternate purchase option was purchased.

4. The method of claim 2, wherein the financial condition relates to a probability of default of a loan of the user.

5. The method of claim 2, further comprising presenting the at least one alternate purchase option as a one-click purchase.

6. The method of claim 1, further comprising computing the loan default probability or financial condition based on at least one of bank account balances, credit card account balances, loan account balances and income.

7. The method of claim 1, wherein the indication is one of a mouse click, product barcode scan and credit card swipe.

8. The method of claim 1, further comprising presenting the interactive notice via text message, email, instant messaging and phone call.

9. The method of claim 1, wherein the threshold is determined by one of the user and a merchant.

10. The method of claim 1, wherein the user adjusts the loan default probability or financial condition by at least one of increasing assets and reducing debts.

11. The method of claim 1, wherein the purchasing transaction is one of virtual and physical.

12. A system comprising:
a processor; and
a non-transitory computer-readable storage medium storing instructions which, when executed on the processor, perform operations comprising:
receiving an indication of a purchasing transaction initiation to purchase a product at a price by a user;
performing an analysis of an effect the purchase of the product, if completed, would have on a financial condition of the user;
Presenting at least a portion of the analysis to at least one of the user and merchant to yield a presentation;
receiving an indication from the merchant of an adjusted price for the product based on the presentation;
receiving a second analysis of an effect the purchase of the product at the adjusted price, if completed, would have on the user; and
completing the purchasing transaction at the adjusted price when the second analysis yields a result below a threshold.

13. The system of claim 12, further comprising charging a fee to the merchant for the presentation.

14. The system of claim 12, wherein the presentation further comprises a loan default probability based on at least one additional adjusted price.

15. The system of claim 12, wherein the merchant sets the adjusted price such that the result is below the threshold.

16. The system of claim 12, further comprising performing the analysis and the second analysis based on at least one of bank account balances, credit card account balances, loan account balances and income.

17. A non-transitory computer-readable storage medium storing instructions which, when executed by a computing device, cause the computing device perform operations comprising:
receiving an indication of a purchasing transaction initiation of a product by a user;
prior to completion of the purchasing transaction, performing an analysis, assuming the completion of the purchase, of an effect of the purchase on a financial condition of the user;
Presenting an interactive notice to the user indicating that a change in the financial condition of the user would occur if the purchasing transaction where to be completed when the analysis yields a result which is above the threshold;
receiving from the user via the interactive notice one of an indication to complete the purchasing transaction and an indication to discontinue the purchasing transaction; and
providing an instruction to continue with the purchasing transaction when the indication is to complete the purchasing transaction.

18. The non-transitory computer-readable storage medium of claim 17, wherein when the indication is not to continue with the purchasing transaction, presenting a time based financial schedule that the user can accept and adopt which enables the user to complete the purchasing transaction at a later date and without reducing the user's financial condition.

19. The non-transitory computer-readable storage medium of claim 17, further comprising presenting the interactive notice via text message, email, instant messaging and phone call.

20. The non-transitory computer-readable storage medium of claim 17, wherein the user adjusts the financial condition by at least one of increasing assets and reducing debts.
